(19) United States
(12) Patent Application Publication
(10) Pub. No.: US 2010/0047556 A1
(43) Pub. Date: Feb. 25, 2010

(54) Decorative coating of glass or glass-ceramic articles

(75) Inventors: Matthias Bockmeyer, Mainz (DE); Gabriele Roemer-Scheuermann, Ingelheim (DE); Andrea Anton, Hueffelsheim (DE); Hans-Joachim Schmitt, Ockenheim (DE)

Correspondence Address: Charles N. J. Ruggiero, Esq.;Ohlandt, Greeley, Ruggiero & Perie, L.L.P., 10th Floor, One Landmark Square, Stamford, CT, 06901-2682, US

(73) Assignee: SCHOTT AG

(21) Appl. No.: 12/459,643

(22) Filed: Jul. 6, 2009

(30) Foreign Application Priority Data
Jul. 4, 2008 (DE) 10 2008 031 428.5

(51) Int. Cl. B32B 5/22; C03B 19/00; B05D 3/02; B32B 19/00; B32B 17/00; C03B 8/02

(52) U.S. Cl. 428/324; 428/432; 428/323; 428/427; 428/428; 427/279; 427/376.2; 65/17.2

(57) ABSTRACT

The invention relates to the production and use of a gray hue palette for decorative coatings based on a sol-gel method for glass and glass-ceramic articles, wherein flake-form pigments and solid lubricant are used in specific mass ratios as decorative pigments. The pigmentation provides a high-temperature-stable decorative layer, has good adhesive strength between the substrate and the decorative layer, has good impermeability relative to fluids and gases during use, as well as a high resistance to scratching. The invention further relates to glass or glass-ceramic articles with decorative coatings which are produced, in particular, according to the method of the invention, which are suitable particularly for use as glass-ceramic cooktops due to the named good layer properties of the decorative layer.

### CROSS REFERENCE TO RELATED APPLICATIONS

This application claims benefit under 35 U.S.C. §119(a) of German Patent Application No. 10-2008-031 428.5, filed Jul. 4, 2008, the entire contents of which are incorporated herein by reference.

### BACKGROUND OF THE INVENTION

1. Field of the Invention

In general, the invention relates to decorative coatings on glass or glass-ceramic articles and especially a method for the production of different color hues as colorings for coatings that are subjected to thermal, mechanical and chemical stresses.

2. Description of Related Art

Glass and, in particular, glass-ceramic articles are frequently used in hot environments, e.g., as a component of cooktops. High requirements for the temperature stability of the materials are placed on the decorative coatings that are used. Other factors, however, must also be considered simultaneously, such as, for example, the adhesive strength and resistance to scratching, as well as impermeability relative to the penetration of fluids and gases that may arise when the article is used, as well as factors which are caused by the system. The impermeability of the decorative layer or the sealing layer, e.g., for use as an underside coating for glass-ceramic cooktops, is an important criterion for the manufacturer of these articles, since the lack of impermeability during use can cause optical changes including damage to the glass or glass-ceramic substrate.

The adhesive strength also plays a particularly decisive role, e.g., in the underside coating of cooktops and is critical with respect to the composition of the coloring substance. Therefore, appliance manufacturers also place special requirements on the adhesive strength of the bonding agent/cooktop system, which also must be fulfilled by a decorative underside coating of cooktops. In particular, a detachment of the underside coating from the substrate must not occur. Components of the incorporated electronics of a cooktop may scrape or scratch the underside of the glass ceramics, thus directly affect the underside coating in the case of cooking surfaces that are coated on the underside. In addition, the coating that is produced shall be impermeable to liquid substances and substances that contain oil, as are found, for example, in foods. Specific substances that arise due to the system may also be present, however, which must not have any disadvantageous effect on the coated glass or glass-ceramic articles. Here, for example, for gas-heated glass-ceramic cooktops, it is thought that sulfur oxides that arise together with water during gas combustion are converted to acids, which can attack both the substrate as well as the decorative layer.

Decorative coatings on glass and glass ceramics, e.g., for use as underside coatings, are known. Generally a first coloring layer is introduced directly on the transparent glass/glass-ceramic article that has not been volume-colored. This first layer usually has a certain adhesive strength and resistance to scratching. The impermeability relative to penetration of liquid or gaseous media, in particular, however, is frequently insufficient with respect to the high requirements in the field of underside-coated cooktops. Therefore, a two-layer construction has been selected for the most part, in which the decorative coating is provided with another sealing layer.

A method for the production of functional glass-like, preferably colored or colloidally colored layers on substrates is known from EP 0729442 A1. The functional glass-like layers are produced by hydrolysis and condensation, e.g., on the basis of a sol-gel process, from hydrolyzable silanes, organosilanes and optional compounds of glass-forming elements, as well as molecular-disperse or nanoscale functional carriers. The following are named as coloring elements: temperature-stable coloring substances and pigments (e.g., soot pigments), metal oxides (e.g., TiO₂) or nonmetal oxides, coloring metal ions, metal colloids or metal-compound colloids and metal ions, which react to form metal colloids under reducing conditions. The coating made of a mixture of these components is applied onto a substrate and is thermally densified into a glass-like layer. The quantity of functional carriers to be added each time is thus aligned according to the desired functional properties of the coating to be produced, e.g., the desired color intensity or opacity. Crack-free coatings with high thermal, mechanical and chemical stability can be produced on metal, glass and ceramic surfaces with this method.

EP 1218202 A1 describes a method for the production of imprinted substrates, in which a printing paste is introduced imagewise onto a substrate and is densified by heat treatment (preferably between 400 and 800° C.). This method is suitable for the production of conductive printing pastes, in particular conductive screen-printing or serigraphy pastes for imprinting substrates with conductive components, such as, e.g., conductive tracks. The printing paste comprises a matrix-forming condensate, which is based on polyorganosiloxanes, and is obtained according to the sol-gel method, and one or more coloring, luminescent, conductive, and/or catalytically acting fillers. Any heat-stable materials, preferably ceramics, glass ceramics and glass, can be used as the substrate. The requirement for heat-stable materials is due to the heat treatment in the course of the method.

DE 10355160 A1 refers to a transparent, uncolored glass/glass-ceramic plate which is subjected to high thermal loads during operation and which has a visually densely colored, high-temperature-stable coating in the form of an organic/inorganic network structure provided with coloring pigments over the entire surface or parts of the surface. In this case, the inorganic network structure is preferably formed by a sol-gel layer, in which color pigments and filler particles are introduced in a pre-specified quantity ratio. The pigment/sol mixing ratio is usually 1:1 referred to the weight; in the case of well-covering pigments, the fraction can be reduced to 20 wt. %. Spinel-based pigments, oxidic pigments and zirconium-based pigments, but also glitter pigments are named as possible pigments. The mixture obtained is applied as a colored coating onto the glass/glass-ceramic plate and under thermal conditions which do not lead to a fusion reaction between the colored layer and the coated surface; i.e., it is baked in at comparatively low temperatures. Another, outer sealing layer which is impermeable to oil and water is preferably applied onto the surface of the decorative layer produced. The layers produced according to the method of the invention will also have a sufficient adhesive strength of the layer on the substrate, even at temperatures that occur under continuous operation of a cooking surface (e.g., 700° C. for 10 h).

As the given prior art shows, the realization of a large color-space spectrum is basically possible in the production of pigmented layers based on sol-gel, which appears to be limited only by the high-temperature-stable pigments that are available. In practical terms, however, it has been shown in many tests that the layer properties depend dramatically on the pigmentation that is used. It has been shown surprisingly that a high quality coating, in particular, of glass-ceramic articles, is not trivial, insofar as the layers shall be stable to high temperatures, stable for a long time, and can be stressed mechanically as well as chemically.

### BRIEF SUMMARY OF THE INVENTION

The object of the invention is thus to provide a high-temperature-stable decorative coating for glass and, in particular, glass ceramics, which has good layer properties in terms of adhesive strength between substrate and coating, impermeability relative to the penetration of fluids and gases, as well as resistance to scratching.

This object is accomplished in a simple manner by the present disclosure. Advantageous embodiments and enhancements are given herein.

It has been found surprisingly that the above-named criteria very much depend on the pigment composition and the ratio of different, specific pigment components. If one deviates from an optimal ratio, there is an over-proportional deterioration of the layer properties, particularly with regard to adhesive strength and impermeability.

The decorative layers according to the invention for glass and glass-ceramic substrates are produced by means of a sol-gel method and contain flake-form pigment particles as a decorative pigment and inorganic, preferably non-oxidic, solid lubricant in a specific weight percent ratio. The ratio of flake-form pigment particles (wt. %):solid lubricant (wt. %) thus lies in a range of 10:1 to 1:1, preferably 5:1 to 1:1 and particularly preferably 3:1 to 1.5:1. The use of a solid lubricant, particularly in the above-given weight percent ratio, has been demonstrated to be very advantageous with respect to the adhesive strength and impermeability of the decorative layer relative to oily and aqueous fluids. Surprisingly, other composition ratios have clearly poorer properties, not only with respect to impermeability, but particularly also with respect to adhesive strength, which represents an essential factor for coatings of the described type.

Accordingly, the invention provides a method for the production of decorative layers on glass or glass-ceramic substrates by means of a sol-gel method, wherein decorative pigments and fillers are added to the sol and the mixture that is formed is hardened by baking in with the formation of a decorative layer, whereby flake-form pigment particles as decorative pigment and solid lubricant in a mass ratio of 10:1 (10 parts of flake-form pigment particles to 1 part of solid lubricant) to 1:1, preferably 5:1 (5 parts of flake-form pigment particles to 1 part of solid lubricant) to 1:1, particularly preferably 3:1 to 1.5:1 are added. The pigmentation of the layer, however, may also contain additional pigments. The proportion of additional pigments, however, preferably does not exceed 15% of the total mass of the pigments.

With this method a glass or glass-ceramic article with a decorative coating according to the invention is obtained, which comprises a glass or glass-ceramic substrate with a decorative layer, wherein the decorative layer contains a hardened sol-gel binding agent which forms a metal oxide network, decorative pigments, solid lubricant and fillers if needed, wherein the weight percent ratio between flake-form pigment particles and solid lubricant is equal to 10:1 to 1:1, preferably 5:1 to 1:1 and particularly preferably 3:1 to 1.5:1.

Different shades of color, in particular gray and gold color hues for decorative layers can be produced by mixing flake-form pigment particles and solid lubricant in different ratios, where the decorative layers have very good properties, in particular with respect to the adhesive strength between the substrate and the applied decorative layer as well as impermeability relative to the penetration of fluids and gases, which arise when the glass or glass-ceramic article is used. Optionally, small quantities of other pigments can be introduced in order to obtain a specific optical esthetic appearance or colorations. If larger quantities of other pigments are added, then there is, of course, a rapid deterioration of the named layer properties, in particular, the properties of adhesive strength and impermeability that are critical for the underside coating of cooking plates, for example.

According to the invention, a layer with good adhesive strength is understood to mean that the layer is not detached in an adhesive tape test in accordance with DIN 58196-6. In this case, differently pre-conditioned test samples are used (e.g., after baking in, after loading with steam, chilling or quenching, or other condition). Alternatively a crockmeter test in accordance with DIN 58196-5 is conducted, wherein again there is no detachment of the layer. In general, a hardened decorative layer can have a resistance to stripping at least equivalent to category 2 in accordance with DIN 58196-6 within the composition range of the pigments according to the invention. A slight polishing effect due to local smoothing of the layer is permissible, however.

The resistance to scratching is determined according to the invention by means of a scratch test with a tungsten carbide tip having a 0.75 mm diameter and different support weights. A good scratch test in the sense of the invention is then achieved if there is no layer abrasion with s support weight of 500 g.

A glass or glass-ceramic article with decorative layer produced with the method according to the invention, in particular, comprises a glass or glass-ceramic substrate with a decorative layer in different color hues, preferably in gray or gold hues, which consist of at least one hardened sol-gel binding agent with decorative pigments in a composition according to the invention and optional fillers, and which fulfills the above-named criteria with respect to adhesive strength, resistance to scratching and impermeability.

The use of flake-form pigments, whose average length of the largest cross section lies in a ratio of 10:1 to 1:3, preferably 8:1 to 1:1, particularly preferably 6:1 to 2:1, relative to the dry layer thickness of the decorative layer, is particularly advantageous for impermeability, but also for the optical esthetic appearance of the decorative layer produced. The use of flake-form pigments, whose diameter is clearly larger than the layer thickness of the decorative layer, leads to the circumstance that the pigments are aligned essentially parallel, but in any case not perpendicular, to the substrate surface. This alignment advantageously further reinforces the impermeability of the decorative layer. In addition, such an alignment leads to a reinforcement of the metallic effect in the decorative layer.

In another advantageous embodiment of the invention, flake-form pigment particles are used, which have an aspect ratio of at least 3:1 and their maximum cross-sectional length on average lies between 5 and 120 μm, preferably between 10 and 60 μm. The given size range of the flake-form pigments results from the provision, on the one hand, that flakes that are as large as possible are to be used, since these achieve a particularly good impermeability effect and, on the other hand, however, the particle size does not make processability difficult or impossible. If the decorative layer is introduced, for example, via serigraphy, it is not meaningful if the pigments have sizes in the range of the mesh size of the sieve used or larger, since some of the pigments would be retained by the sieve. Apart from the fact that the decorative layer would then not contain the desired quantity of pigments, frequent idle times for the machinery would ensue, since the sieve would have to be cleansed of the retained flake-form pigments.

In a particularly preferred embodiment, flake-form pigments are used, which have a bimodal distribution of the average maximum cross sections, wherein preferably, the maxima lie in the upper and lower cross-sectional range used. This structure is also particularly advantageous, since, on the one hand, it reinforces the impermeability effect of the decorative layer due to large flake-form pigments, but, on the other hand, it also has a positive effect on the adhesive strength between decorative layer and substrate, which is reinforced by the small flake-form fraction.

Solid lubricants, preferably non-oxidic solid lubricants, in the sense of the invention, are understood to be pigments which have a very low surface energy, which is preferably similar to that of graphite or smaller than this. Non-oxides are particularly preferred for use, whose surface energy at most lies 20% above the surface energy of graphite.

In particular, a layer lattice structure, for example a graphite-like structure has been demonstrated to be advantageous, i.e., a layer structure of pigments, wherein individual layers are joined one under the other only by small bonding forces, which has as a consequence that such pigments show a good lubricating behavior. Due to the layer lattice structure, preferred solid lubricant particles typically have a scaly esthetic appearance. In a favorable manner, the particles in this case are scaly overall.

It has been shown surprisingly that solid lubricants are an important component of the decorative layer, even though only those with a low surface energy are used according to the invention. Only a sufficient quantity, preferably approximately ⅓ to ⅕ of the pigments to be added, assures a good adhesive strength between decorative layer and substrate.

In addition to graphite, among others, boron nitride and many sulfides, particularly also molybdenum disulfide, demonstrate these properties and may be used alternatively.

If graphite is used as a solid lubricant pigment, it is advantageous if up to 90% of it has a particle size which is smaller than a value in the range of 2 to 50 micrometers, preferably smaller than a value in the range of 6 to 19 μm (=D90 value). In this case, the maximum cross-sectional length is used as the particle size. If boron nitride is used in addition to or instead of graphite, it is particularly advantageous if the particle sizes lie between 1 and 100 μm, preferably between 3 and 20 μm, since, as in the case of graphite, the particle size of the added boron nitride has a large influence on the adhesive strength in the finished glass or glass-ceramic article. Particles that are too large consequently have poor adhesive strength.

If graphite is used as the solid lubricant, different gray hues that are particularly decorative can be produced by varying the graphite content within the weight percent ratios according to the invention. The relevant range of color hues, which can be produced with the sol-gel colors of the method according to the invention is given in the Color Space Lab CIELAB color system by the following values:

L: from 85 to 30

a: from −8 to +8

b: from −8 to +8

If boron nitride is used in addition to or alternatively to graphite as a solid lubricant for pigmentation, different gold hues can be produced. These gold hues, in particular, if a large part of the solid lubricant consists of boron nitride, are particularly suitable for coatings which will be used together with capacitive contact switches, since boron nitride, in contrast to graphite, is not electrically conducting. In addition, it is also possible to use boron nitride as a single solid lubricant.

In general, layers according to the invention also demonstrate a high color stability under high temperature loads, which applies to applications of layers on articles that are heated during operation, particularly when they are nonuniformly heated. This particularly applies to glass-ceramic cooktops. It could be demonstrated that typical layers showed a color change D_{LAB} of less than 2 after heating to 500° C. for 6 minutes. Here, D_{LAB} designates the distance of color locations in the Lab Color Space. It is thus assured that there are no recognizable, or, in any case, barely perceptible, color differences even between hot and cold regions of a cooktop.

The decorative layers are based on a hardened sol-gel binding agent, which is produced by hydrolysis and subsequent condensation of at least one organometallic compound, preferably a silicon alkoxide. The use of organometallic compounds has the advantage that the sol-gel binding agent hardens into a metal oxide network, preferably to an SiO₂ network, and particularly preferred, a glassy metal oxide network, to which organic components may also be optionally bonded. The organic residues or components here advantageously improve the water-repelling properties of the decorative layer, for example. Particularly good experience has been achieved for the simultaneous use of tetraethoxysilane and triethoxymethylsilane for the production of the sol-gel binding agent.

Apart from the described fundamental substances, fillers and/or solvents and/or additives can be added to the sol-gel binding agent. In a preferred embodiment, the rheology as well as the processing time can be adjusted by means of additional solvents and/or additives.

In a preferred embodiment, the flake-form pigments comprise mica flakes and/or borosilicate-based flakes and/or metal flakes and/or glass flakes, particularly preferably coated mica flakes and/or metal flakes, which can be coated with TiO₂. Optically pleasing metallic effects or, for example, also the esthetic appearance of star bursts can be produced by means of these pigments. In addition to TiO₂-coated flake-form pigments, a small quantity of other effect pigments, for example Fe₂O₃ or SnO₂-coated flake-form pigments or flake-form pigments, which are heat-treated or coated with a mixture of TiO₂ and Fe₂O₃ or other oxides, preferably up to 6 wt. % of the total amount of the pigmentation, can be added.

It has surprisingly been shown in tests that the weight percent ratios named above according to the invention between flake-form pigments and solid lubricant and optionally additional effect pigments should be maintained, since otherwise there would be a deterioration first of the impermeability of the produced layer relative to oily fluids and subsequently an inadequate adhesive strength between the decorative layer and the substrate. Larger quantities of other effect pigments over-proportionally strongly adversely affect, in particular, the impermeability and adhesive strength of the decorative layers. Spherical particles are preferred as fillers. Pyrogenic silicic acid, which forms small spherical particles, and/or colloidally disperse SiO₂ particles are advantageously contained. Spherical particles as fillers have the effect that the flake-form pigments are aligned predominantly parallel to the surface of the substrate and thus produce the phenomenon of slightly roughened or burnished metal. In addition, it has been shown that such decorative coatings are clearly more resistant, in particular with respect to their resistance to abrasion and scratching.

Particularly good results are achieved if the fraction of filler does not exceed 40 wt. % of the mass of the one or more flake-form pigments in the coating composition. Fillers consisting of colloidally disperse SiO₂ particles and/or pyrogenic silicic acid are preferably used, and their fraction in each case makes up 20 wt. % at most of the mass of the one or more flake-form pigments. A mixture of two types of fillers, which may have different sizes, has been demonstrated to be particularly advantageous for the properties of the decorative layer and/or of the substrate, such as, e.g., its strength.

In a particularly preferred embodiment, the weight fraction of pigment and fillers in the decorative layer is higher than the weight fraction of the solidified and hardened sol-gel binding agent. The fraction of sol-gel binding agent in the decorative layer produced preferably amounts to at most 40 wt. % or only 30 wt. % at most. These mixture ratios act positively on the porosity and the structure of the decorative layer. It has been shown that the layer is surprisingly more elastic and thus different temperature expansion coefficients of the substrate and the decorative layer can be equilibrated. As a consequence, the separation of the decorative layer and/or the formation of strength-reducing microcracks will be avoided in the decorative layer or substrate.

If the sol has been provided with the indicated pigments and fillers, the gel-form sol-gel binding agent is produced by at least partial evaporation of the solvent that has been added and/or has arisen during the reaction. In particular, it can contain the alcohol that forms during the hydrolysis and/or alcohol added as the solvent. The evaporation of the solvent(s) should occur at least partially after introduction onto the substrate.

It is generally possible to introduce the mixture, comprising at least the sol, pigments and fillers, onto the substrate, by painting, spraying or dipping. In a particularly preferred enhancement of the invention, the above-named mixture has a pasty consistency, so that it can be used as a serigraphy paste. In this case, there is the possibility of introducing the decorative layer either over the entire surface as well as over part of the surface or in a laterally structured manner, in particular, by means of serigraphy. The introduction over part of the surface or laterally has the advantage that several decorative layers with different composition and/or esthetic appearance and/or color can be combined, in order to evoke different optical impressions on different regions of the substrate, for example, in order to emphasize the at least one cooking surface from its surroundings.

Another embodiment of the invention includes regions, such as windows for sensors or displays, which are not provided with a decorative layer.

Due to an accelerated condensation reaction during drying at preferably 100 to 250° C., a gel forms with a metal oxide network. Upon baking in at temperatures >350° C., water and/or alcohol are (is) split off from the gel-form sol-gel binding agent with the formation of the solid metal oxide framework, in particular, of the SiO₂ or organically modified SiO₂ framework. In a particularly preferred embodiment, the two method steps of drying and baking in are combined in one process, e.g., with the use of a roller oven.

The decorative layer produced in this way is preferably covered with a sealing layer in order to optimize the layer properties, in particular with respect to impermeability relative to liquid and gaseous substances. The sealing layer may consist of the same material as the decorative layer or it may be otherwise composed. Preferably, if it is produced, however, corresponding to the method according to the invention, but without baking in at very high temperatures, it therefore also has a mass ratio of flake-form pigments to graphite in the scope of the range according to the invention. Correspondingly, the sealing layer is produced by means of a sol-gel method, wherein decorative pigments and fillers are added to the sol and the mixture that is formed is hardened with the formation of the sealing layer, wherein flake-form pigments and solid lubricant will be added in a weight percent ratio of 10:1 to 1:1, preferably 5:1 to 1:1, particularly preferably 3:1 to 1.5:1.

In contrast to the decorative layer, the sealing layer is not baked in; hardening occurs at temperatures of <300° C., preferably 100° C. to 250° C. Therefore, at least 5% more organic components remain in the sealing layer than in the decorative layer, which is baked in at higher temperatures. The additional organic components, among other things, lead to the fact that the sealing layer has certain liquid-repelling properties. These properties are particularly important in the edge regions of the glass or glass-ceramic article according to the invention, since liquid or oily substances which commonly fall on the cooktop in the course of cooking can penetrate here with high probability.

If the sealing layer is also applied in the hot range of cooking surfaces, for example, the organic components may be baked out during the specific use of the cooktop, as in the case of the decorative layer. The sealing effect of the sealing layer is then taken over by the solid lubricants according to the invention, which surprisingly assure a sufficient protection against the penetration of fluids in this region.

It has been shown to be particularly advantageous, if the decorative and sealing layers are produced from the same educts. One batch can then be used advantageously for both layers, which reduces costs and time in production. The stack of layers produced in this way is thus, in general, particularly impermeable relative to the penetration of fluids and shows a very good adhesive strength between substrate and decorative layer.

A good impermeability is defined corresponding to the effective substances, based on the following tests, and refers to a stack of layers, which comprises a decorative layer and a sealing layer.

The impermeability of the coating relative to aqueous and oily media as well as cleaning agents or detergents is defined by means of a drop test. A drop of liquid to be tested is introduced onto the underside coating and left to act for various lengths of time that are specific to the medium. Water drops are washed off after 30 seconds, oil drops after 24 hours, and drops of cleaning agents or detergents after they have acted. Subsequently, the glass/glass-ceramic article is evaluated from above through the substrate. The drop or the shadow of the drop must not be visible. A penetration of the layer by the medium that is introduced is not permitted. The water drop test is additionally conducted on samples with different preconditioning: in the as-delivered state, after annealing, after quenching, after steam loading, etc.

In another test with respect to impermeability relative to oily media, a cut edge of the coating is placed in oil, whereby the time of action varies between one and five minutes. Oil must not creep up to the top.

Impermeability relative to adhesives is determined by introducing a bead of adhesive onto the coating and hardening it there. Different annealings of the samples prepared in this way are optionally conducted. Subsequently, the glass/glass-ceramic article is evaluated from above through the substrate. The drop of adhesive or its shadow must not be visible.

Impermeability relative to sealing materials is carried out analogously, but without the hardening step. The sealing materials or a shadow, which results from the degassing of the sealing materials, must not be visible.

In general, a layer bond is present between a decorative layer according to the invention and a sealing layer as described above, in particular, a sealing layer which contains flake-form pigment particles and solid lubricant just like the decorative layer, and has been subjected to at least one of the above-named impermeability tests.

The decorative layer is characterized by a high porosity. The porosity of the decorative layer is also generally higher than that of a sealing layer which is also based on sol-gel, correspondingly pigmented, but hardened at lower temperatures. Both the decorative layer and the sealing layer are, in general, determined to be smaller than 2 nanometers, in particular smaller than 1.5 nanometers, according to the BJH method, on the basis of absorption, but they are microporous with average pore diameters.

If the inner surface is determined according to a multi-point BET evaluation with nitrogen absorption, in general, values of less than 50 m²/gram can be measured for the sealing layer. Typical values for very good sealing layers are 1-40 m²/gram. In contrast, the values for the decorative layer typically lie above 150 m²/gram. The high porosity of the decorative layer thus appears to be the basis for the good adhesion, even with temperature stress. Values of 200-300 m²/gram have been measured for very well adhering, temperature-stable decorative layers.

The cumulative adsorptive pore volume, measured by the BJH method is less than 0.08 cubic centimeters per gram for typical sealing layers as described above. Thus, for example, a value of 0.048 cubic centimeters per gram was measured on a sealing layer with very good sealing properties. In contrast, the cumulative adsorptive pore volume of a similarly pigmented decorative layer according to the invention is typically greater than 0.1 cubic centimeter per gram. Thus, a cumulative adsorptive pore volume of 0.18 cubic centimeter per gram was measured on a well adhering decorative layer with a pigmentation, like the sealing layers according to the invention.

The invention will be explained in more detail below on the basis of embodiment examples with reference to the drawings. Identical and similar elements are provided with the same reference numbers; the features of different embodiment examples may be combined with one another.

### BRIEF DESCRIPTION OF THE SEVERAL VIEWS OF THE DRAWINGS

FIG. 1 a schematic cross section through a glass or glass-ceramic substrate with a pigmented decorative layer according to the invention, and

FIG. 2 a view onto a glass-ceramic cooktop, which is provided with a pigmented decorative layer according to the invention and a sealing layer.

### DETAILED DESCRIPTION OF THE INVENTION

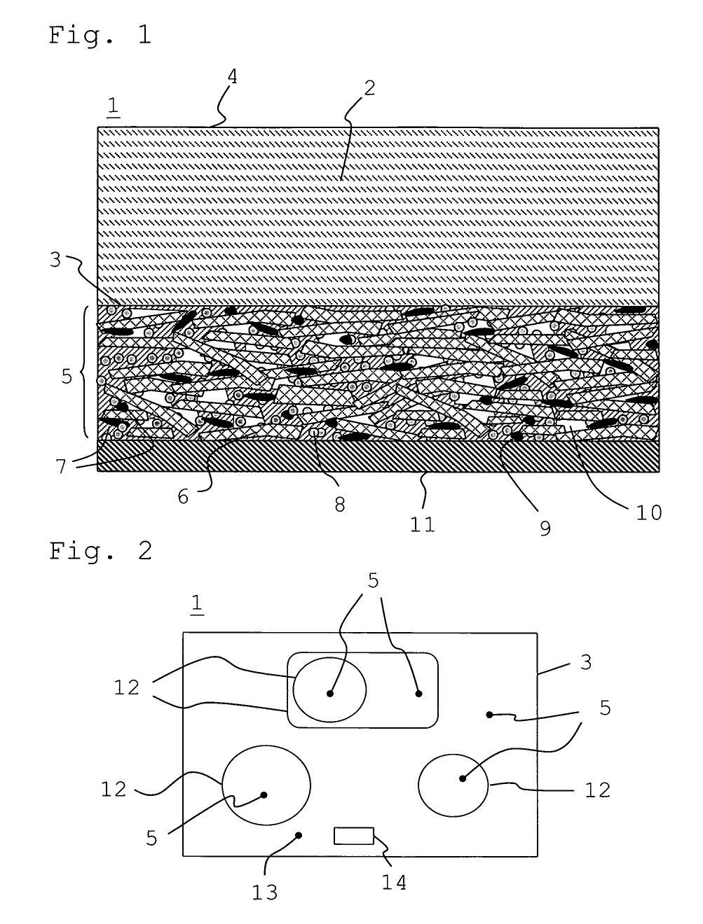

FIG. 1 shows a schematic cross section through a glass or glass-ceramic article 1 with a decorative layer according to the invention. The glass or glass-ceramic article 1 in this example comprises a glass or glass-ceramic substrate 2 with an upper side 4 and an underside 3. Article 1 may be a glass-ceramic cooktop, in particular. A decorative layer 5, which has a pigment composition according to the invention, is introduced on one of the sides 3 or 4. If article 1 involves a glass-ceramic cooktop, decorative layer 5 is particularly preferably introduced on underside 3 of the cooktop in order to prevent wear and tear of the layer due to use.

For the production of decorative layer 5, decorative pigments and fillers are mixed with a sol, the mixture is applied as a layer onto the substrate, preferably by means of serigraphy, and the resulting gel-form binding agent is hardened onto the glass or glass-ceramic substrate 2 by baking in.

The decorative pigments used comprise flake-form pigments 6 and solid lubricant 7 according to the invention, which are contained in a mass ratio of 10:1 to 1:1, preferably of 3:1 to 1:1, particularly preferably of 3:1 to 1.5:1. Preferably, mica flakes and/or borosilicate-based flakes and/or glass flakes, particularly preferably coated mica flakes and/or borosilicate-based flakes and/or glass flakes, and most preferably TiO₂-coated mica flakes and/or borosilicate-based flakes are used as the flake-form pigments.

In a special embodiment, synthetic mica pigments may also be used as flake-form pigments. In another preferred embodiment, the flake-form mica pigments can be coated with cobalt oxide and iron oxide.

Filler particles 8 are also contained in layer 5 in addition to the decorative pigments. Filler particles 8 and decorative pigment particles 6, 7 are also combined into a solid layer by a sol-gel binding agent 9, wherein the weight fraction of pigment particles 6, 7 and filler particles 8 is higher than the weight fraction of the solidified and hardened sol-gel binding agent. In the case of a decorative layer 5 as shown in FIG. 1, the fraction of sol-gel binding agent 9 is preferably at most 40 wt. %, or only at most 30 wt. % of the total mass of layer 5. Pores 10 remain due to the high fraction of solids or due to the small fraction of solgel binding agent. The overall porous layer is comparatively flexible, so that differences in the temperature expansion coefficients between substrate 2 and decorative layer 5 can be equilibrated.

A gel-form sol-gel binding agent, to which are added the different pigment mixtures described further below, can be represented as follows:

A mixture of tetraethoxyorthosilane (TEOS) and triethoxymethylsilane (TEMS) is produced, in which alcohol can be added as a solvent. An aqueous metal oxide dispersion, in particular, a SiO₂ dispersion, in the form of colloidally disperse SiO₂ particles, is mixed with acid, preferably hydrochloric acid or another mineral acid, such as sulfuric acid. The two mixtures produced separately can be stirred for an improved homogenization. Subsequently, the two mixtures are combined and mixed. Advantageously, this mixture can be aged, for example, for one hour, preferably with continuous stirring. Parallel to the batch of this mixture, the pigments and optionally other fillers, preferably pyrogenic silicic acid, can be weighed out, added to the aging mixture and dispersed. The pyrogenic silicic acid and/or the colloidal SiO₂ dispersion supply the spherical filler particles 8 for the finished decorative layer 5. The fraction of fillers thus amounts to less than 20 wt. % of the mass of the one or more flake-form pigments. Overall, the weight fraction of filler particles thus preferably amounts to at most 10 wt. % of the weight fraction of the pigment particles.

Different solvents, rheological additives and other additives can be added to the mixture, as a function of how the mixture is applied.

This sol is converted by evaporating the alcohol and by polycondensation of the hydrolyzed TEOS and TEMS in a metal oxide gel. This process is accelerated after the application of the mixture onto substrate 2 by drying at temperatures between 100 and 250° C., so that the applied layer solidifies with the formation of the gel. If, for example, TEOS and/or TEMS are used as educts, a SiO₂ network is formed, particularly also an at least partially methyl-substituted SiO₂ network. The subsequent baking in of the dried layer at temperatures preferably >350° C. concludes the reaction to the SiO₂ network and leads to a densification of the decorative layer 5 produced in this way.

In the example of embodiment shown in FIG. 1, the flake-form pigment particles 6 are predominantly aligned parallel to the surface of the substrate. A predominantly parallel alignment is understood according to the invention to mean that the angular distribution of the surface normal lines of pigment particles 6 is not stochastic, but rather has a clear maximum in the direction of the surface normal lines of the substrate surface. This ordering of the pigment particles is achieved particularly simply by the use of fillers 8 with spherical geometry. The ordering of the flake-form pigment particles 6 has the advantage that the metallic effect is reinforced and the decorative layer 5 that is produced also has an improved resistance to scratching and abrasion.

In the case of the example of embodiment shown in FIG. 1, the decorative layer 5 is covered with a sealing layer 11. Sealing layer 11 may contain silicones, for example, in order to improve the water-repelling properties of the coating. Alternatively or additionally, however, it may also be a SiO₂-based barrier coating. It may be introduced by sputtering, vaporizing, plasma-induced chemical vapor deposition or also pyrolytic deposition, for example, from a flame or corona.

Of course, an additional sol-gel coating is particularly preferably applied, wherein the sealing layer 11 has the same or a similar composition to that of the decorative layer 5, thus also has solid lubricant and flake-form pigment particles, and can be produced, in particular, corresponding to the method according to the invention.

Pigment compositions are presented below, which make possible particularly good layer properties relative to the decorative layer produced:

The “black” pigmentation contains 67 weight percent of calcium aluminium borosilicate coated with silicon dioxide, titanium oxide, stannic oxide (flake-form pigment) and 33 weight percent of high-crystalline graphite with a D90 value of 5-8 micrometers. Excellent layer properties with respect to adhesive strength and resistance to scratching as well as impermeability of the coating are achieved with this mixture. The decorative layer is colored dark-gray and shows a metallic effect. In combination with a suitable sealing layer, all criteria for use of this pigment mixture in decorative underside coatings of a cooking surface are fulfilled.

In combination with a suitable sealing layer, a decorative layer with this pigmentation fulfills requirements with respect to adhesive strength, impermeability and resistance to scratching, which are placed, for example, on a glass-ceramic cooktop when the above-given tests are applied.

According to a first formulation for the pigmentation of a sealing layer according to the invention, 84 weight percent of a flake-form, TiO₂ and SnO₂-coated mica-based effect pigment with a particle size in the range of 1 to 15 micrometers and 6 weight percent of another flake-form, TiO₂, Fe₂O₃ and SnO₂-coated mica-based effect pigment with a particle size in the range of 5 to 25 micrometers containing 10 weight percent of high-crystalline graphite with a D90 value of 15 to 20 micrometers are combined. This pigmentation may also be used for the production of a decorative layer.

According to a second formulation for the pigmentation of a sealing layer according to the invention, 66 weight percent of a flake-form, TiO₂ and SnO₂-coated mica-based effect pigment with a particle size in the range of 10 to 60 micrometers and 5 weight percent of another flake-form, TiO₂, Fe₂O₃, SiO₂ and SnO₂-coated mica-based effect pigment with a particle size in the range of 5 to 25 micrometers containing 33 weight percent of high-crystalline graphite with a D90 value of 5 to 8 micrometers are combined. This pigmentation may also be used for the production of a decorative layer. In particular, the coating can be constructed with the same formulation for the decorative and sealing layers.

According to a third formulation for the pigmentation of a decorative layer according to the invention, 63 weight percent of a flake-form cobalt oxide and iron oxide-coated synthetic mica-based effect pigment with a particle size in the range of 5 to 60 micrometers and 3 weight percent of another flake-form, TiO₂, Fe₂O₃, SiO₂ and SnO₂-coated mica-based effect pigment with a particle size in the range of 10 to 120 micrometers containing 32 weight percent of high-crystalline graphite with a D90 value of 5 to 8 micrometers are combined. This pigmentation may also be used for the production of a decorative layer. In particular, the coating can be constructed with the same formulation for the decorative and sealing layers.

The three above-given embodiment examples may also be combined, of course, with one another, whereby one of the formulations is used for the production of the decorative layer and the other formulation is used for the production of the sealing layer.

If, in addition to graphite, boron nitride is used as a solid lubricant for the pigmentation, titanium, high-quality alloy steel, gold, bronze and brass hues of different brightness can be produced. These shades, in particular, if a large part of the solid lubricant consists of boron nitride, are particularly suitable for coatings which will be used together with capacitive contact switches, since boron nitride, in contrast to graphite, is not electrically conducting. The pigment composition, given in wt. % each time, of some bright coatings which possess the good properties according to the invention, are listed below:

Pigmentation “A”: 7 weight percent of high-crystalline graphite with a D90 value of 15 to 20 micrometers, 15 weight percent of boron nitride powder with a D50 value of 7 micrometers with a specific surface of 4 to 6 square meters per gram, 7 weight percent of a flake-form, TiO₂ and SnO₂-coated mica-based effect pigment with a particle size in the range of 1 to 15 micrometers, 12 weight percent of a flake-form, TiO₂, Fe₂O₃, SiO₂ and SnO₂-coated mica-based effect pigment with a particle size in the range of 5 to 25 micrometers, 59 weight percent of a flake-form, TiO₂ and SnO₂-coated mica-based effect pigment with a particle size in the range of 10 to 60 micrometers.

A bright metallic bronze hue or a brass-colored hue with a fine burnished esthetic appearance is achieved with this pigmentation.

Pigmentation “B”: 3.6 weight percent of high-crystalline graphite with a D90 value of 5 to 8 micrometers, 38.7 weight percent of boron nitride powder with a D50 value of 7 micrometers with a specific surface of 4 to 6 square meters per gram, 39.6 weight percent of a flake-form, TiO₂- and SnO₂-coated mica-based effect pigment with a particle size in the range of 1 to 15 micrometers, 5.5 weight percent of a flake-form, TiO₂ and SnO₂-coated mica-based effect pigment with a particle size in the range of 10 to 40 micrometers, 12.6 weight percent of a flake-form, TiO₂- and SnO₂-coated mica-based effect pigment with a particle size in the range of 10 to 60 micrometers.

A bright titanium color hue with a metallic effect is achieved with this pigmentation.

In all of the above-described formulations, the ratio of the weight percents of flake-form pigment particles and solid lubricant is in the range between 6:1 and 1:1.

FIG. 2 shows a coated glass-ceramic article 1 according to the invention in the form of a glass-ceramic cooktop. The decorative layer 5 provided with a sealing layer 11 (not shown) is found on the underside 3 of the glass-ceramic cooktop 2. Cooktop 2 has several heating zones 12, under which are disposed heating elements. Heating zones 12 can be defined or demarcated from the unheatable surroundings 13, for example, by decorative layers 5 of different gray and/or gold hues and/or esthetic appearance and/or composition. This may have, for example, an esthetic function or even a function characterizing the cooking zones 12. Advantageously, regions 14 without decorative layer may also be left blank, so that these regions can be used, for example, as areas for sensors and/or also for a display.

The decorative layer 5 with the pigmentation according to the invention is not only sufficiently temperature-stable, but is also able to sufficiently well conduct the heat produced by the heating elements for cooking on the cooktop. It has been particularly shown that the optical pattern of decorative coating 5 in the hot region 12 is not altered or at least is not noticeably altered even after long operation.

It is obvious to the person skilled in the art that the invention is not limited to the exemplary embodiments described above, but rather can be varied in many ways. In particular, the features of the individual embodiment examples may also be combined with one another.

What is claimed is:

1. A method for the production of decorative layers on glass or glass-ceramic substrates, comprising:
forming decorative pigments comprising flake-form pigment particles and solid lubricant, the flake-form pigment particles being in a weight percent ratio to the solid lubricant in the range of 10:1 to 1:1;
adding the decorative pigments and fillers to a sol to form a mixture; and
hardening the mixture by baking.

2. The method according to claim 1, wherein the weight percent ratio is in the range of 5:1 to 1:1.

3. The method according to claim 1, wherein the weight percent ratio is in the range of 3:1 to 1.5:1.

4. The method according to claim 1, wherein the solid lubricant comprises an inorganic solid lubricant selected from the group consisting of graphite, boron nitride, molybdenum sulfide, an inorganic non-oxide, and combinations thereof.

5. The method according to claim 4, wherein the inorganic solid lubricant has a surface energy which is at most 20% higher than the surface energy of graphite.

6. The method according to claim 1, wherein the inorganic solid lubricant comprises graphite having a maximum cross-sectional length that is smaller than 6 to 19 μm.

7. The method according to claim 1, wherein the inorganic solid lubricant comprises boron nitride having an average particle size between 1 and 100 μm.

8. The method according to claim 1, wherein the inorganic solid lubricant comprises boron nitride having an average particle size between 3 and 20 μm.

9. The method according to claim 1, further comprising using a sol-gel binding agent produced from a sol containing at least tetraethoxysilane and triethoxymethylsilane.

10. The method according to claim 1, wherein the flake-form pigment particles comprises particles selected from the group consisting of mica flakes, borosilicate-based flakes, metal flakes, glass flakes, coated mica flakes, coated borosilicate-based flakes, coated metal flakes, coated glass flakes, and combinations thereof.

11. The method according to claim 1, further comprising:
producing a paste from the decorative pigments, fillers, and the sol; and
applying the paste by serigraphy onto the glass or glass-ceramic substrate.

12. The method according to claim 11, further comprising applying pastes of different composition and/or esthetic appearance and/or color onto different regions of the glass or glass-ceramic substrate.

13. The method according to claim 1, further comprising laterally structuring the decorative layer.

14. The method according to claim 1, further comprising drying the mixture at a temperature between 100 to 250° C. before hardening the mixture by baking.

15. The method according to claim 14, wherein hardening the mixture by baking comprises baking the mixture at temperatures of at least 350° C.

16. The method according to claim 1, further comprising sealing the decorative layer with a sealing layer.

17. The method according to claim 16, wherein sealing the decorative layer with the sealing layer comprises:
forming decorative pigments comprising flake-form pigment particles and solid lubricant, the flake-form pigment particles being in a weight percent ratio to the solid lubricant in the range of 10:1 to 1:1;
adding decorative pigments and fillers to a sol to form a mixture; and
hardening the mixture.

18. The method according to claim 16, wherein sealing the decorative layer with the sealing layer comprises:
introducing the sealing layer onto the hardened decorative layer; and
hardening the sealing layer at temperatures of less than 300° C.

19. The method according to claim 16, wherein the decorative layer and the sealing layer are produced from the same educts.

20. A glass or glass-ceramic article, comprising:
a glass or glass-ceramic substrate;
a decorative coating comprising hardened sol-gel binding agent forming a metal oxide network and decorative pigments, wherein the decorative pigments comprising flake-form pigment particles and solid lubricant in weight percent ratio of flake-form pigment particles to solid lubricant equal to 10:1 to 1:1

21. The glass or glass-ceramic article according to claim 20, wherein the weight percent ratio is equal to 5:1 to 1:1.

22. The glass or glass-ceramic article according to claim 20, wherein the weight percent ratio is equal to 3:1 to 1.5:1.

23. The glass or glass-ceramic article according to claim 20, wherein the decorative coating further comprising fillers.

24. The glass or glass-ceramic article according to claim 20, wherein the flake-form pigment particles have a ratio of an average length of the largest cross section relative to the dry layer thickness of the decorative layer of 10:1 to 1:3.

25. The glass or glass-ceramic article according to claim 20, wherein the flake-form pigment particles have an aspect ratio of at least 3:1 and a largest cross-sectional length of the flake-form pigment particless lies on average between 5 and 120 μm.

26. The glass or glass-ceramic article according to claim 25, wherein the largest cross-sectional length lies on average between 10 and 60 μm.

27. The glass or glass-ceramic article according to claim 20, wherein the solid lubricant comprises an inorganic solid lubricant selected from the group consisting of graphite, boron nitride, molybdenum sulfide, inorganic non-oxide, and combinations thereof.

28. The glass or glass-ceramic article according to claim 27, wherein the inorganic solid lubricant has surface energy which is at most 20% higher than the surface energy of graphite.

29. The glass or glass-ceramic article according to claim 20, wherein the solid lubricant comprises graphite particles having a maximum cross-sectional length smaller than 6 to 19 μm.

30. The glass or glass-ceramic article according to claim 20, wherein the solid lubricant comprises boron nitride particles having an average particle size between 1 and 100 μm.

31. The glass or glass-ceramic article according to claim 30, wherein the average particle size is between 3 and 20 μm.

32. The glass or glass-ceramic article according to claim 20, wherein the flake-form pigment particles have a bimodal distribution of average maximum cross sections.

33. The glass or glass-ceramic article according to claim 20, wherein the flake-form pigment particles comprise particles selected from the group consisting of mica flakes, borosilicate-based flakes, metal flakes, glass flakes, coated mica flakes, coated borosilicate-based flakes, coated metal flakes, coated glass flakes, TiO₂ coated flake-form pigments, cobalt oxide coated flake-form pigments, iron oxide-coated flake-form pigments, and combinations thereof.

34. The glass or glass-ceramic article according to claim 20, further comprising a sealing layer sealing the decorative layer.

35. The glass or glass-ceramic article according to claim 34, wherein the sealing layer comprises a hardened solgel layer containing flake-form pigment particles, solid lubricant, and fillers, wherein the flake-form pigment particles and solid lubricants are present in a weight percent ratio in the range of 10:1 to 1:1.

36. The glass or glass-ceramic article according to claim 20, wherein the decorative layer comprises graphite as a solid lubricant and has a gray hue that lies in a range comprising the values L=85 to 30, a=−8 to +8, b=−8 to +8 in the CIELAB color system.
